(19) United States
(12) Patent Application Publication
(10) Pub. No.: US 2025/0208431 A1
(43) Pub. Date: Jun. 26, 2025

(54) OPTICAL ELEMENT DRIVING MECHANISM

(71) Applicant: TDK TAIWAN CORP., Taoyuan City (TW)

(72) Inventors: Yu-Chiao LO, Taoyuan City (TW); Yi-Ho CHEN, Taoyuan City (TW); Chia-Che WU, Taoyuan City (TW)

(21) Appl. No.: 18/989,651

(22) Filed: Dec. 20, 2024

Related U.S. Application Data
(60) Provisional application No. 63/612,581, filed on Dec. 20, 2023.

(51) Int. Cl. G02B 27/64; G02B 7/08

(52) U.S. Cl. CPC G02B 27/646; G02B 7/08

(57) ABSTRACT

An optical element driving mechanism is provided. The optical element driving mechanism includes a fixed assembly, a movable assembly and a driving assembly. The movable assembly is configured to connect an optical element, and the movable assembly is movable relative to the fixed assembly. The driving assembly is configured to drive the movable assembly to move relative to the fixed assembly. The fixed assembly includes an accommodating space configured to accommodate the optical element.

### CROSS REFERENCE TO RELATED APPLICATIONS

This application claims the benefit of U.S. Provisional Application No. 63/612,581, filed Dec. 20, 2023, the entirety of which is incorporated by reference herein.

### BACKGROUND OF THE INVENTION

### Field of the Disclosure

The present disclosure relates to an optical element driving mechanism, and in particular it relates to an optical element driving mechanism with a long focal length and anti-shake functionality.

### Description of the Related Art

As technology has developed, many of today's electronic devices (such as smartphones) have a built-in camera and video-recording functionality. Using the camera modules disposed in electronic devices, users can operate their electronic devices to capture photographs and record videos.

Today's design of electronic devices continues to follow the trend of miniaturization, meaning that the various components of the camera module and its structure must also be continuously reduced in size, so as to achieve miniaturization. In general, the driving mechanism in a camera module has a camera lens holder configured to hold a camera lens, and the driving mechanism can perform the functions of auto focusing and optical image stabilization. Although existing driving mechanisms can achieve the aforementioned functions needed in photography and video recording, they still cannot meet all the needs of users.

Therefore, how to design a camera module capable of performing autofocus, optical anti-shake functions and achieving miniaturization at the same time are topics nowadays that need to be discussed and solved.

### BRIEF SUMMARY OF THE INVENTION

Accordingly, one objective of the present disclosure is to provide an optical element driving mechanism to solve the problems described above.

According to some embodiments of the disclosure, an optical element driving mechanism is provided that includes a fixed assembly, a movable assembly and a driving assembly. The movable assembly is configured to connect an optical element, and the movable assembly is movable relative to the fixed assembly. The driving assembly is configured to drive the movable assembly to move relative to the fixed assembly. The fixed assembly includes an accommodating space configured to accommodate the optical element.

According to some embodiments, the fixed assembly includes a casing and a base. The casing is fixedly connected to the base along a main axis. The casing has a first opening, and when viewed along the main axis, the optical element is exposed from the first opening. The casing has a second opening, and when viewed along a first axis, the optical element is exposed from the second opening. The first opening is connected to the second opening. An external light is emitted into the first opening along an optical axis and then enters the optical element, and then emitted from the optical element and the second opening along the first axis. According to some embodiments, the movable assembly includes a first movable part and a second movable part. The first movable part is movably connected to the second movable part. The second movable part is movably connected to the base. The driving assembly includes a first driving element and a first coil. The first driving element is disposed on the first movable part. The optical element driving mechanism further includes a circuit assembly, and the first coil is disposed on the circuit assembly. The first driving element is configured to act with the first coil to generate a first electromagnetic driving force to drive the first movable part to rotate around a first rotating axis relative to the second movable part. According to some embodiments, the driving assembly further includes a second driving element, a third driving element, a second coil and a third coil. The second driving element and the third driving element are disposed on the second movable part. The second coil is disposed on the base. The third coil is disposed on the circuit assembly. The second driving element is configured to act with the second coil to generate a second electromagnetic driving force, and the third driving element is configured to act with the third coil to generate a third electromagnetic driving force, so that the second electromagnetic driving force and the third electromagnetic driving force cooperatively drive the first movable part and the second movable part to rotate around a second rotating axis relative to the base. The first rotating axis is perpendicular to the second rotating axis. The first rotating axis is perpendicular to the first axis. The second rotating axis is parallel to the main axis.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a three-dimensional schematic diagram of an optical element driving mechanism 100 according to an embodiment of the present disclosure.

FIG. 2 is a schematic exploded diagram of the optical element driving mechanism 100 according to an embodiment of the present disclosure.

FIG. 3 is a perspective view of a partial structure of the optical element driving mechanism 100 in another view according to an embodiment of the present disclosure.

FIG. 4 is a perspective view of a partial structure of the optical element driving mechanism 100 according to an embodiment of the present disclosure.

FIG. 5 is a perspective view of a partial structure of the optical element driving mechanism 100 in another view according to an embodiment of the present disclosure.

FIG. 6 is a three-dimensional cross-sectional view of the optical element driving mechanism 100 along the line A-A in FIG. 1 according to an embodiment of the present disclosure.

FIG. 7 is a perspective view of a partial structure of the optical element driving mechanism 100 according to an embodiment of the present disclosure.

FIG. 8 is a cross-sectional view of the optical element driving mechanism 100 along the line B-B in FIG. 1 according to an embodiment of the present disclosure.

FIG. 9 is a three-dimensional cross-sectional view of the optical element driving mechanism 100 along the line C-C in FIG. 1 according to an embodiment of the present disclosure.

FIG. 10 is a cross-sectional view of the optical element driving mechanism 100 along line D-D in FIG. 1 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

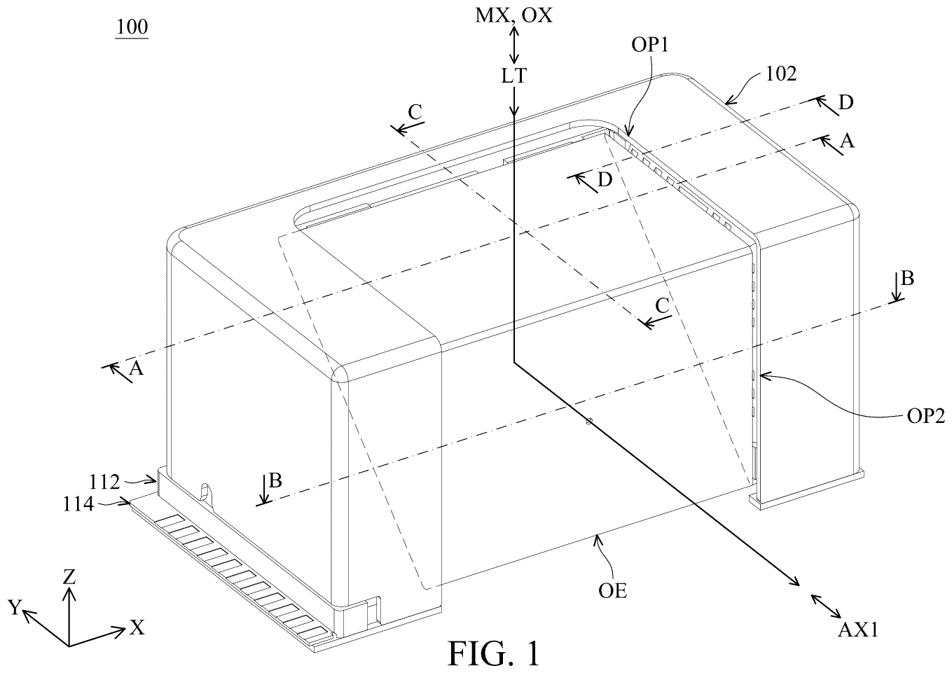

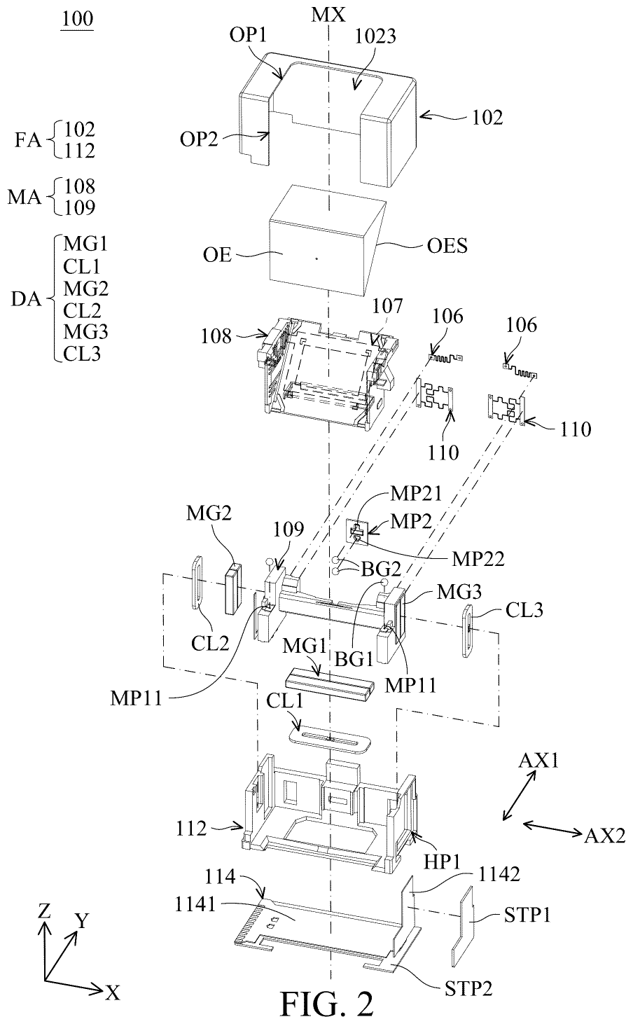

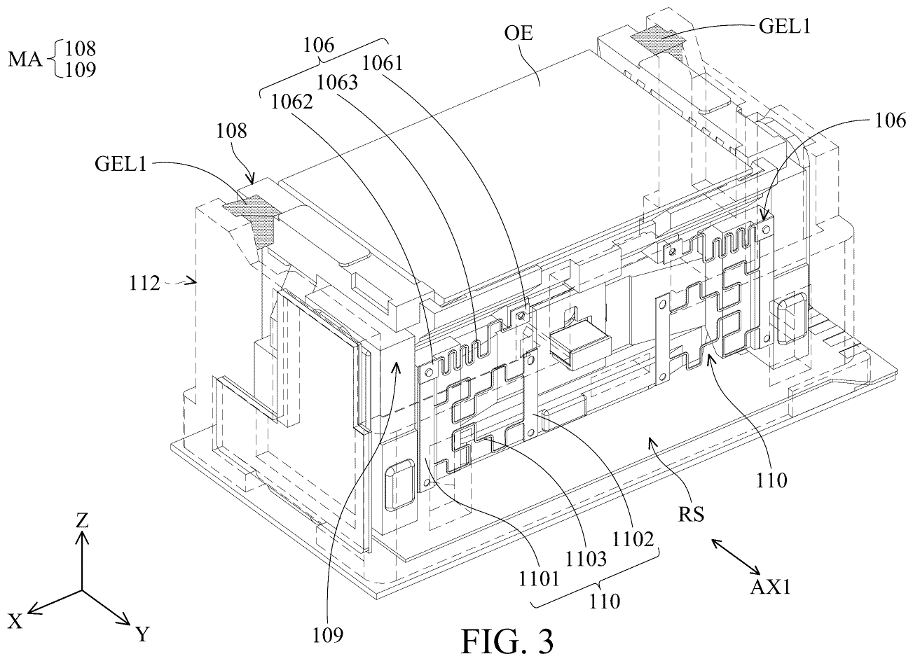

Please refer to FIG. 1 to FIG. 3. FIG. 1 is a three-dimensional schematic diagram of an optical element driving mechanism 100 according to an embodiment of the present disclosure. FIG. 2 is a schematic exploded diagram of the optical element driving mechanism 100 according to an embodiment of the present disclosure, and FIG. 3 is a perspective view of a partial structure of the optical element driving mechanism 100 in another view according to an embodiment of the present disclosure. The optical element driving mechanism 100 may be an optical camera module configured to carry and drive an optical element OE.

The optical element driving mechanism 100 can be installed on various electronic devices or portable electronic devices, such as smart phones, so that users can perform image capturing functions. In this embodiment, the optical element driving mechanism 100 may be a voice coil motor (VCM) with an auto-focus (AF) function, but the present disclosure is not limited thereto. In other embodiments, the optical element driving mechanism 100 may also have automatic focus (AF) and optical image stabilization (OIS) functions.

As shown in FIG. 2, the optical element driving mechanism 100 may include a fixed assembly FA, a movable assembly MA, and a driving assembly DA. The movable assembly MA is configured to connect the aforementioned optical element OE, and the movable assembly MA is movable relative to the fixed assembly FA. The driving assembly DA is configured to drive the movable assembly MA to move relative to the fixed assembly FA.

In this embodiment, the fixed assembly FA includes a casing 102 and a base 112, and the casing 102 is fixedly connected to the base 112 along a main axis MX to form an accommodating space 1023 to accommodate the optical element OE. The casing 102 may have a first opening OP1, and when viewed along the main axis MX, the optical element OE is exposed from the first opening OP1. The optical element OE can be a reflective prism, but it is not limited thereto.

As shown in FIG. 1 and FIG. 2, the casing 102 further has a second opening OP2, and when viewed along a first axis AX1, the optical element OE is exposed from the second opening OP2. The first opening OP1 is connected to the second opening OP2, and an external light LT is emitted into the first opening OP1 along an optical axis OX and then enters the optical element OE, and then is reflected by a reflective surface OES of the optical element OE, and then emitted from the optical element OE and second opening OP2 along the first axis AX1.

In this embodiment, the movable assembly MA may include a first movable part 108 and a second movable part 109. The first movable part 108 is movably connected to the second movable part 109, and the second movable part 109 is movably connected to the base 112.

Specifically, as shown in FIG. 2 and FIG. 3, the optical element driving mechanism 100 may further include two first elastic members 106, which are connected between the first movable part 108 and the second movable part 109. Each of the first elastic members 106 may have a first connecting terminal 1061, a second connecting terminal 1062, and a first flexible portion 1063.

The first connecting terminal 1061 is fixedly connected to the first movable part 108, the second connecting terminal 1062 is fixedly connected to the second movable part 109, and the first flexible portion 1063 is connected between the first connecting terminal 1061 and the second connecting terminal 1062.

Similarly, the optical element driving mechanism 100 further includes two second elastic members 110, which are connected between the second movable part 109 and the base 112. Each of the second elastic members 110 has a third connecting terminal 1101, a fourth connecting terminal 1102 and a second flexible portion 1103.

The third connecting terminal 1101 is fixedly connected to the second movable part 109, the fourth connecting terminal 1102 is fixedly connected to the base 112, and the second flexible portion 1103 is connected between the third connecting terminal 1101 and the fourth connecting terminal 1102.

The first elastic members 106 and the second elastic members 110 may be metal elastic spring sheets, but they are not limited thereto. In addition, the number of first elastic member 106 and second elastic member 110 is not limited thereto embodiment. It is worth noting that the first elastic members 106 and the second elastic members 110 are both located on a rear side RS of the movable assembly MA.

As shown in FIG. 3, the second connecting terminal 1062 has a plate-shaped structure and is located on a first plane, and the third connecting terminal 1101 has a plate-shaped structure and is located on a second plane. In this embodiment, the first plane is parallel to the second plane. In addition, the first plane may overlap the second plane, but it is not limited thereto.

In addition, it should be noted that in FIG. 3, in order to clearly show the configuration of the first elastic members 106 and the second elastic members 110, the base 112 is represented by a dotted line, but it does not mean that the base 112 does not exist.

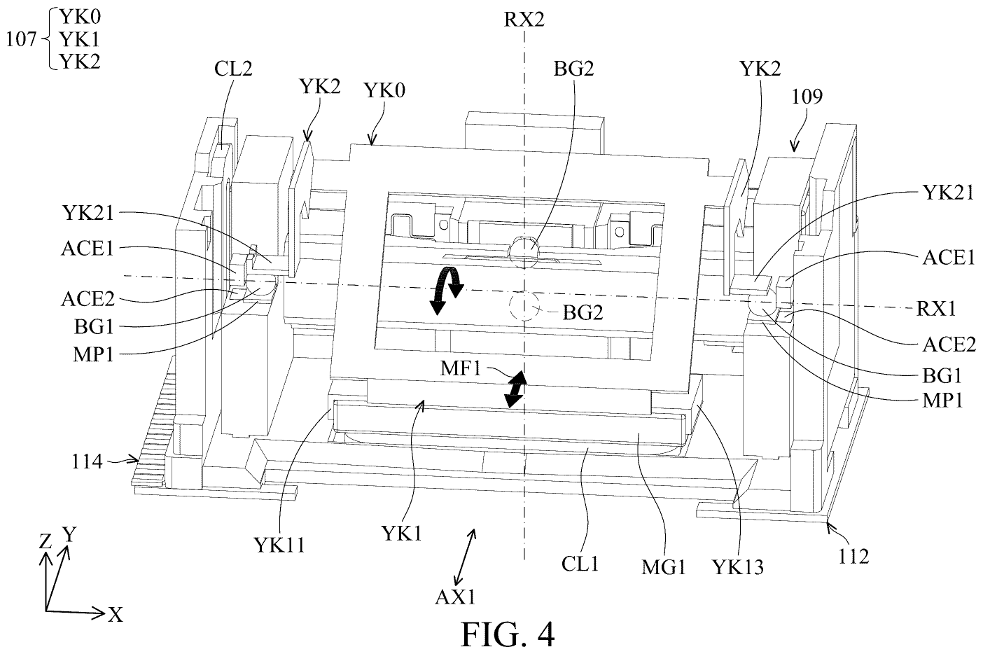

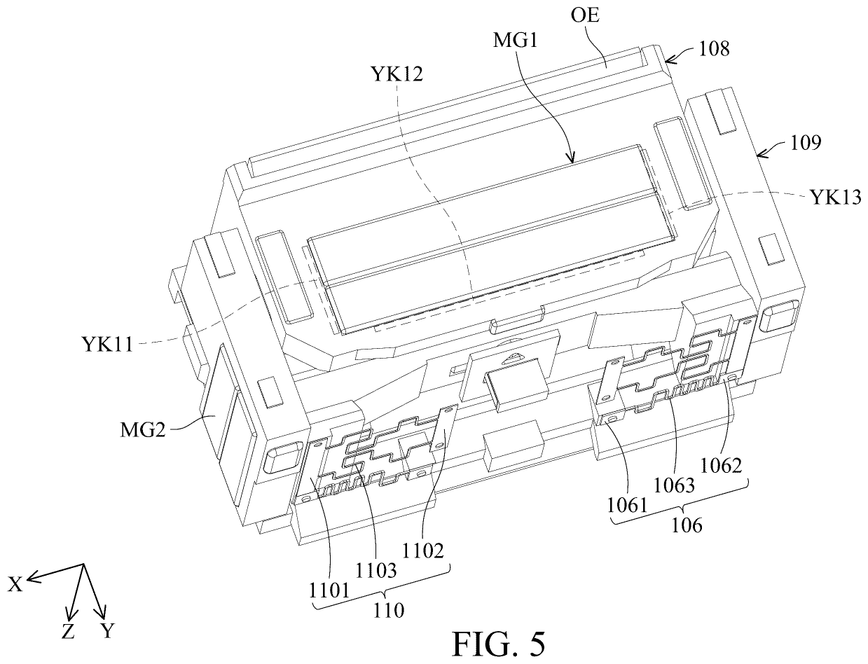

Next, please refer to FIG. 2, FIG. 4 and FIG. 5. FIG. 4 is a perspective view of a partial structure of the optical element driving mechanism 100 according to an embodiment of the present disclosure, and FIG. 5 is a perspective view of a partial structure of the optical element driving mechanism 100 in another view according to an embodiment of the present disclosure. As shown in FIG. 2, the optical element driving mechanism 100 further includes a first reinforcement member 107, which is partially embedded in the first movable part 108.

As shown in FIG. 4, the first reinforcement member 107 may have a reinforced base portion YK0 and a first reinforcement structure YK1, the first reinforcement structure YK1 is fixedly connected to the reinforced base portion YK0, and the reinforced base portion YK0 and at least a portion of the first reinforcement structure YK1 are disposed in the first movable part 108.

As shown in FIG. 4, when viewed along the first axis AX1, the reinforced base portion YK0 is a rectangular frame-shaped structure which is embedded in the first movable part 108. Because the first reinforcement member 107 can be made of metal material, the reinforced base portion YK0 can enhance the overall structural strength of the first movable part 108.

Furthermore, as shown in FIG. 2 and FIG. 4, the driving assembly DA may include a first driving element MG1 and a first coil CL1. The first driving element MG1 is fixedly disposed on the bottom of the first movable part 108.

Correspondingly, the optical element driving mechanism 100 may further include a circuit assembly 114, and the first coil CL1 is disposed on the circuit assembly 114. The circuit assembly 114 is, for example, a flexible printed circuit board (FPC board), but it is not limited thereto.

In this embodiment, the first driving element MG1 is configured to act with the first coil CL1 to generate a first electromagnetic driving force MF1 to drive the first movable part 108 to rotate around a first rotating axis RX1 relative to the second movable part 109. For example, the first movable part 108 performs a pitch motion relative to the second movable part 109 and the base 112.

As shown in FIG. 4 and FIG. 5, the first driving element MG1 is disposed on the first reinforcement structure YK1, and a portion of the first reinforcement structure YK1 is located between the first driving element MG1 and the first movable part 108.

It is worth noting that, as shown in FIG. 5, the first reinforcement structure YK1 may have a first side portion YK11, a second side portion YK12 and a third side portion YK13, which are arranged on three sides of the first driving element MG1. The first side portion YK11 is adjacent to the second side portion YK12, and the second side portion YK12 is adjacent to the third side portion YK13.

Because the first reinforcement member 107 can have magnetic permeability, based on the configuration of the first side portion YK11 to the third side portion YK13, the magnetic field strength of the first driving element MG1 can be increased, and the magnetic attraction force is generated between the first driving element MG1 and the first reinforcement structure YK1 to increase the convenience and positioning accuracy of installing the first driving element MG1 on the first reinforcement structure YK1.

Furthermore, as shown in FIG. 2 and FIG. 4, the optical element driving mechanism 100 may further include two first guiding elements BG1, which are disposed between the first movable part 108 and the second movable part 109 and are configured to guide the first movable part 108 to rotate around the first rotating axis RX1. Specifically, the first rotating axis RX1 is defined by the two first guiding elements BG1, and the first rotating axis RX1 passes through the two first guiding elements BG1.

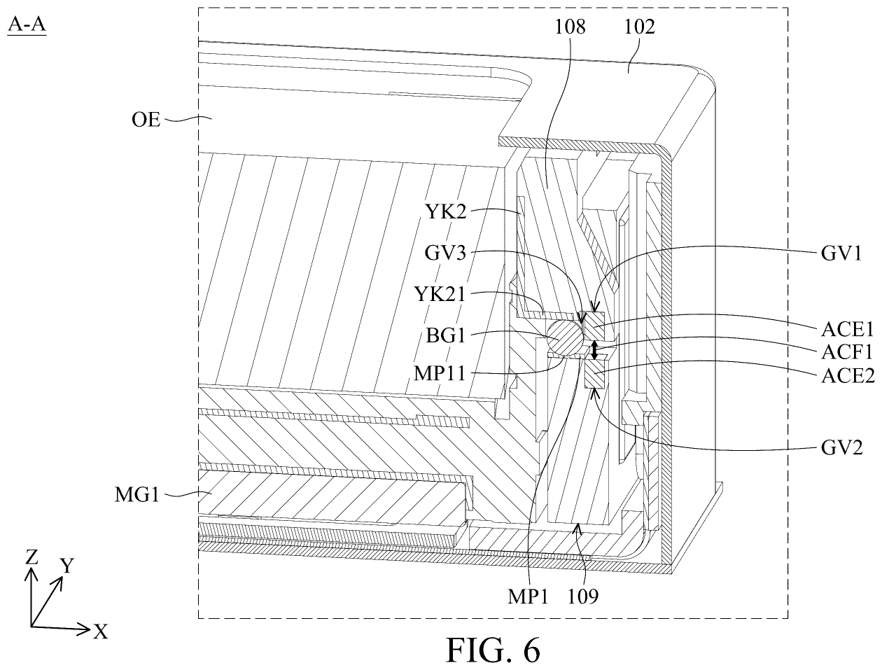

Next, please refer to FIG. 2, FIG. 4 and FIG. 6. FIG. 6 is a three-dimensional cross-sectional view of the optical element driving mechanism 100 along the line A-A in FIG. 1 according to an embodiment of the present disclosure. In this embodiment, the optical element driving mechanism 100 further includes two first plate bodies MP1, which are fixedly disposed on the second movable part 109. Each first plate body MP1 is, for example, a metal sheet body, but it is not limited thereto.

Each of the two first plate bodies MP1 has a first recess MP11 configured to accommodate a portion of the corresponding first guiding element BG1. As shown in FIG. 6, a portion of the first guiding element BG1 is accommodated in the first recess MP11.

Furthermore, as shown in FIG. 4 and FIG. 6, the optical element driving mechanism 100 may further include two second reinforcement structures YK2, which are partially disposed in the first movable part 108. The second reinforcement structures YK2 are fixedly connected to the reinforced base portion YK0, and the reinforced base portion YK0 is connected between the two second reinforcement structures YK2.

In this embodiment, the reinforced base portion YK0, the first reinforcement structure YK1 and the second reinforcement structure YK2 can be integrally formed as one pieced, but they are not limited thereto. Furthermore, the first reinforcement member 107 can be a yoke, but it is not limited thereto.

As shown in FIG. 4 and FIG. 6, each of the second reinforcement structures YK2 may have a first contact portion YK21 configured to contact the corresponding first guiding element BG1. Therefore, each of the two first guiding elements BG1 is clamped by the corresponding first contact portion YK21 and the first plate body MP1.

In this embodiment, the first plate body MP1 can be made of metal material, and the first guiding elements BG1 can be made of ceramic material, but they are not limited thereto. In this embodiment, the hardness of the first guiding element BG1 may be greater than the hardness of the first contact portion YK21 or the first plate body MP1. Based on this configuration, the problem of particles generated by friction between the first guiding element BG1 and the first plate body MP1 can be avoided.

In addition, because the first movable part 108 and the second movable part 109 can be made of plastic material, the configuration of the first contact portion YK21 and the first plate body MP1 can also enhance the structural strength of the first movable part 108 and the second movable part 109, so as to avoid the first guiding element BG1 from damaging the first movable part 108 or the second movable part 109.

In this embodiment, as shown in FIG. 4 and FIG. 6, the optical element driving mechanism 100 may further include two first attracting elements ACE1, which are fixedly disposed on the first movable part 108. The first movable part 108 may have two first grooves GV1 configured to respectively accommodate two first attracting elements ACE1.

Correspondingly, the optical element driving mechanism 100 further includes two second attracting elements ACE2, which are fixedly arranged on the second movable part 109 and respectively correspond to the two first attracting elements ACE1. The second movable part 109 may have two second grooves GV2 configured to respectively accommodate two second attracting elements ACE2.

The two first attracting elements ACE1 and the two second attracting elements ACE2 can be made of magnetic materials. For example, the first attracting elements ACE1 and the second attracting elements ACE2 can be magnets, but they are not limited thereto. For example, one of the first attracting element ACE1 and the second attracting element ACE2 can be a magnet, and the other one can be a magnetically permeable sheet.

The first attracting element ACE1 is configured to generate a first magnetic attraction force ACF1 with the corresponding second attracting element ACE2, and the first magnetic attraction force ACF1 can be parallel to the main axis MX (the Z-axis), but it is not limited thereto.

The aforementioned two first magnetic attraction forces ACF1 are configured to drive the first movable part 108 toward the second movable part 109 to ensure that the first movable part 108 is not separated from the second movable part 109 when rotating around the first rotating axis RX1 relative to the second movable part 109.

As shown in FIG. 6, the first movable part 108 further has two third grooves GV3, configured to accommodate the two first guiding elements BG1 and the two first contact portions YK21, and the third groove GV3 is connected to the corresponding first groove GV1.

It is worth noting that the first attracting element ACE1 is adjacent to the corresponding first contact portion YK21. Therefore, an attractive force (such as a magnetic attraction force) can be generated between the first attracting element ACE1 and the corresponding first contact portion YK21, so that the first attracting element ACE1 can be easily installed in the first groove GV1.

As shown in FIG. 4, when viewed along the first axis AX1, the two first guiding elements BG1 are located between the two first attracting elements ACE1, and when viewed along the first axis AX1, the two first guiding elements BG1 are Located between the two second attracting elements ACE2. The first attracting element ACE1 and the second attracting element ACE2 are adjacent to the corresponding first guiding element BG1.

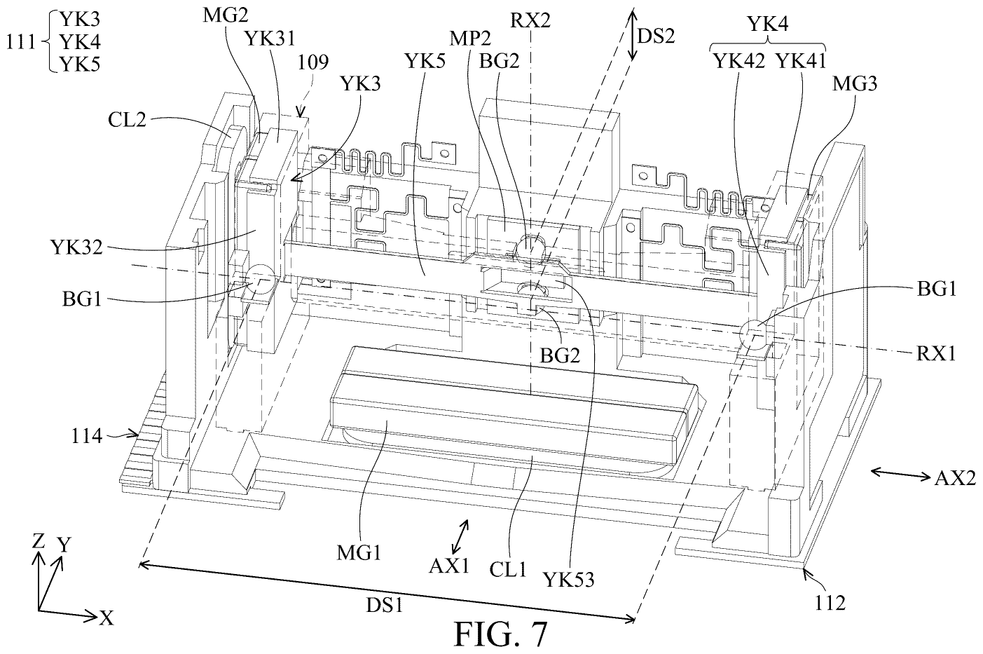

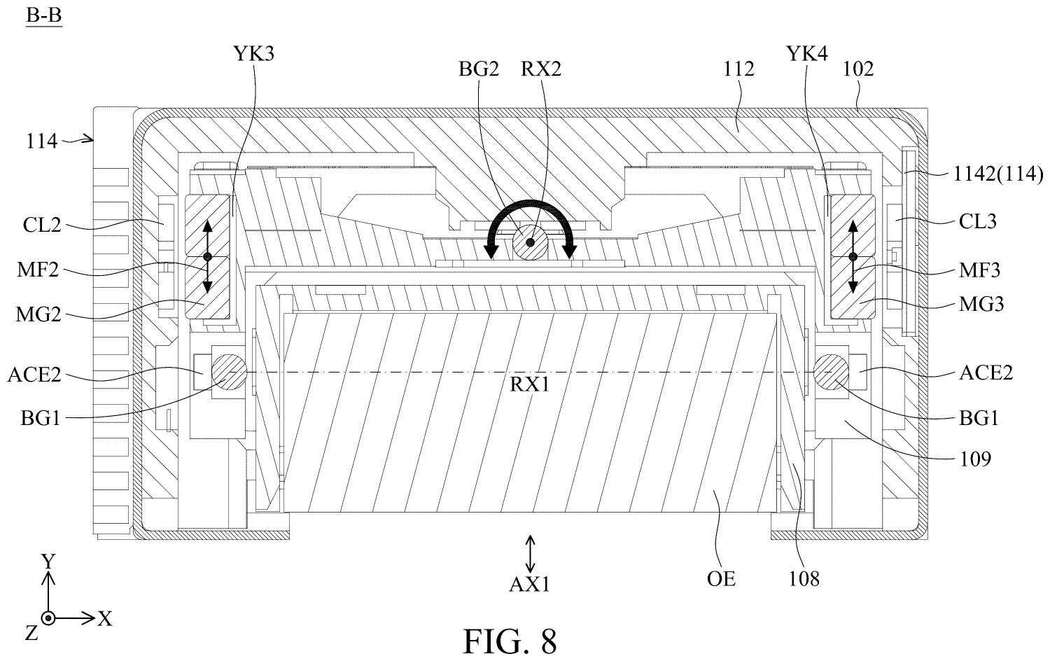

Next, please refer to FIG. 2, FIG. 7 and FIG. 8. FIG. 7 is a perspective view of a partial structure of the optical element driving mechanism 100 according to an embodiment of the present disclosure, and FIG. 8 is a cross-sectional view of the optical element driving mechanism 100 along the line B-B in FIG. 1 according to an embodiment of the present disclosure. It should be noted that in FIG. 7, in order to clearly show the internal structure, the second movable part 109 is represented by a dotted line, but it does not mean that the second movable part 109 does not exist.

In this embodiment, the driving assembly DA may further include a second driving element MG2, a third driving element MG3, a second coil CL2 and a third coil CL3. The second driving element MG2 and the third driving element MG3 are disposed on the second movable part 109, and the second coil CL2 is disposed on the base 112. The second coil CL2 can be electrically connected to the circuit assembly 114 through the circuit structure (such as metal wires, not shown in the figures) which is formed in the base 112 by the insert molding technology, and the third coil CL3 is disposed on the circuit assembly 114.

The first driving element MG1, the second driving element MG2 and the third driving element MG3 can be magnets, such as multi-pole magnets, but they are not limited thereto.

As shown in FIG. 7, the optical element driving mechanism 100 may further include a second reinforcement member 111, which is disposed on the second movable part 109. The second reinforcement member 111 may include a third reinforcement structure YK3 and a fourth reinforcement structure YK4, which are partially disposed in the second movable part 109. The second driving element MG2 is disposed on the third reinforcement structure YK3, and a portion of the third reinforcement structure YK3 is located between the second driving element MG2 and the second movable part 109.

Specifically, the third reinforcement structure YK3 has a fourth side portion YK31 and a fifth side portion YK32, which are disposed on two sides of the second driving element MG2, and the fourth side portion YK31 is adjacent to the fifth side portion YK32. The third reinforcement structure YK3 can be made of metal material and has magnetic permeability, so that the second driving element MG2 can be reliably positioned on the second movable part 109.

Similarly, the third driving element MG3 is disposed on the fourth reinforcement structure YK4, and a portion of the fourth reinforcement structure YK4 is located between the third driving element MG3 and the second movable part 109. The fourth reinforcement structure YK4 has a sixth side portion YK41 and a seventh side portion YK42, which are disposed on two sides of the third driving element MG3.

The sixth side portion YK41 is adjacent to the seventh side portion YK42. Similarly, because the fourth reinforcement structure YK4 can be made of metal material and has magnetic permeability, the third driving element MG3 can be reliably positioned on the second movable part 109.

Furthermore, the second reinforcement member 111 of the optical element driving mechanism 100 may further include a fifth reinforcement structure YK5, which is partially disposed in the second movable part 109, and the third reinforcement structure YK3 and the fourth reinforcement structure YK4 are fixedly connected to fifth reinforcement structure YK5. In this embodiment, the fifth reinforcement structure YK5 can be made of metal material, and the third reinforcement structure YK3, the fourth reinforcement structure YK4 and the fifth reinforcement structure YK5 can be integrally formed as one piece, but it is not limited thereto.

It is worth explaining that, as shown in FIG. 8, when viewed along the main axis MX (the Z-axis), the second movable part 109 has a U-shaped structure. Based on the configuration of the fifth reinforcement structure YK5, it can increase the overall structural strength of the second movable part 109 and avoid damage to the middle part of the second movable part 109 due to movement or impact.

As shown in FIG. 8, the second driving element MG2 is configured to act with the second coil CL2 to generate a second electromagnetic driving force MF2, and the third driving element MG3 is configured to act with the third coil CL3 to generate a third electromagnetic driving force. MF3, so that the second electromagnetic driving force MF2 and the third electromagnetic driving force MF3 can cooperatively drive the first movable part 108 and the second movable part 109 to rotate around a second rotating axis RX2 relative to the base 112.

The directions of the second electromagnetic driving force MF2 and the third electromagnetic driving force MF3 are opposite. For example, when the second electromagnetic driving force MF2 is oriented towards the −Y-axis, the third electromagnetic driving force MF3 is oriented towards the +Y-axis, so that the second electromagnetic driving force MF2 and the third electromagnetic driving force MF3 can cooperatively drive the second movable part 109 and the first movable part 108 to rotate counterclockwise around the second rotating axis RX2.

On the contrary, when the second electromagnetic driving force MF2 is oriented towards the +Y-axis, the third electromagnetic driving force MF3 is oriented towards the −Y-axis, so that the second electromagnetic driving force MF2 and the third electromagnetic driving force MF3 can cooperatively drive the second movable part 109 and the first movable part 108 to rotate clockwise around the second rotating axis RX2.

As shown in FIG. 7, the first rotating axis RX1 is perpendicular to the second rotating axis RX2, the first rotating axis RX1 is perpendicular to the first axis AX1, and the second rotating axis RX2 is parallel to the main axis MX (the Z-axis), but they are not limited thereto.

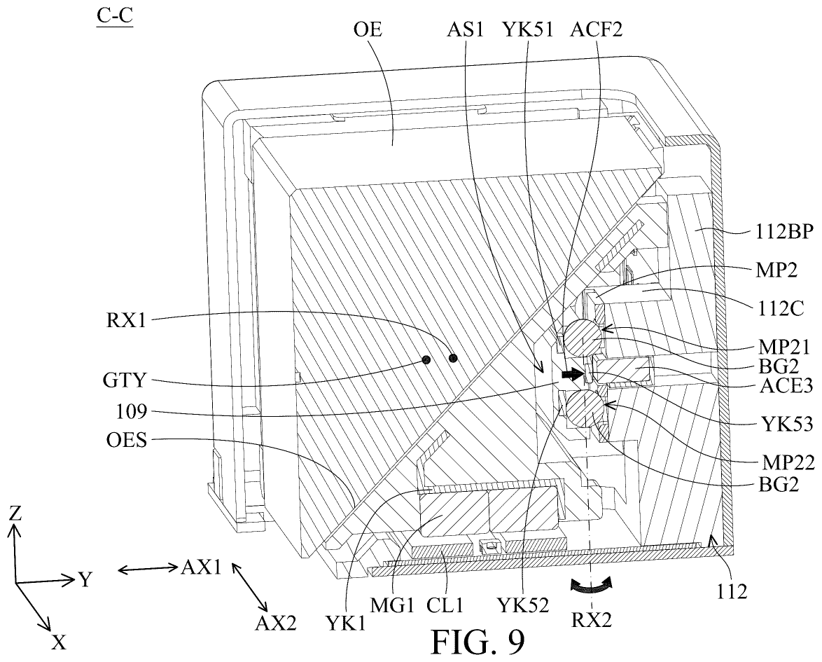

Please refer to FIG. 2, and FIG. 7 to FIG. 9. FIG. 9 is a three-dimensional cross-sectional view of the optical element driving mechanism 100 along the line C-C in FIG. 1 according to an embodiment of the present disclosure. In this embodiment, the optical element driving mechanism 100 further includes two second guiding elements BG2, which are disposed between the second movable part 109 and the base 112 and are configured to guide the second movable part 109 and the first movable part 108 to rotate around the second rotating axis RX2.

As shown in FIG. 7 and FIG. 9, the second rotating axis RX2 is defined by the two second guiding elements BG2, and the second rotating axis RX2 passes through the two second guiding elements BG2. Furthermore, the optical element driving mechanism 100 further includes a second plate body MP2, which is fixedly disposed on the base 112.

As shown in FIG. 9, when viewed along a second axis AX2, the two second guiding elements BG2 are located between the second movable part 109 and the second plate body MP2. The second axis AX2 is perpendicular to the first axis AX1.

As shown in FIG. 7, in the direction of the second axis AX2, there is a first distance DS1 between the two first guiding elements BG1, in the direction of the main axis MX, there is a second distance between the two second guiding elements BG2 distance DS2, and second distance DS2 is different from first distance DS1. In this embodiment, the second distance DS2 is less than the first distance DS1.

As shown in FIG. 2 and FIG. 9, the second plate body MP2 has a second recess MP21 and a third recess MP22, which are configured to respectively accommodate a portion of the two second guiding elements BG2. Correspondingly, the fifth reinforcement structure YK5 may have a second contact portion YK51 and a third contact portion YK52, configured to respectively contact the two second guiding elements BG2.

Therefore, one of the two second guiding elements BG2 (the upper one in FIG. 9) is clamped by the second contact portion YK51 and the second plate body MP2, and the other of the two second guiding elements BG2 (the lower one in FIG. 9) is clamped by the third contact portion YK52 and the second plate body MP2.

Furthermore, as shown in FIG. 9, the first movable part 108 has a first accommodating space AS1, and a portion of the second movable part 109 (for example, the middle part) is located in the first accommodating space AS1. In addition, the base 112 has a back plate 112BP and a protruding portion 112C, and the protruding portion 112C is protruded from the back plate 112BP toward the second movable part 109 along the first axis AX1.

Similarly, a portion of the protruding portion 112C is also located in the first accommodating space AS1. Therefore, this configuration can achieve the purpose of miniaturization of the optical element driving mechanism 100.

In this embodiment, the optical element driving mechanism 100 may further include a third attracting element ACE3, which is fixedly disposed on the protruding portion 112C. The third attracting element ACE3 is made of magnetic material, and the third attracting element ACE3 is, for example, a magnet. Correspondingly, the fifth reinforcement structure YK5 can be made of magnetically conductive material.

Specifically, as shown in FIG. 7 and FIG. 9, the fifth reinforcement structure YK5 can have a bending structure YK53, which is located between the second contact portion YK51 and the third contact portion YK52, and the bending structure YK53 is bent toward the protruding portion 112C. When viewed along the second axis AX2, a portion of the bending structure YK53 does not overlap the second contact portion YK51 or the third contact portion YK52.

The third attracting element ACE3 is configured to generate a second magnetic attraction force ACF2 with the bending structure YK53, and the second magnetic attraction force ACF2 is parallel to the first axis AX1. The second magnetic attraction force ACF2 is configured to drive the fifth reinforcement structure YK5 to drive the second movable part 109 to move toward the base 112, so that the fifth reinforcement structure YK5 and the second plate body MP2 cooperatively clamp the two second guiding elements BG2, thereby ensuring that the second movable part 109 is not separated from the base 112 when rotating around the second rotating axis RX2 relative to the base 112.

In addition, it is worth noting that, as shown in FIG. 9, the first movable part 108 and the optical element OE may cooperatively have a center of gravity GTY, and when viewed along the second axis AX2, the center of gravity GTY and the first rotating axis RX1 are both on the same side of the reflective surface OES (the upper left side in FIG. 9).

Because the center of gravity GTY is closer to the first rotating axis RX1, the torque generated by the center of gravity GTY relative to the first rotating axis RX1 is smaller, so that the first movable part 108 can rotate around the first rotating axis RX1 more stable.

Then please return to FIG. 3. In order to ensure the stability of the first movable part 108 and the second movable part 109 when moving, and to prevent the first movable part 108 or the second movable part 109 from colliding with the base 112 when the optical element driving mechanism 100 is impacted, the optical element driving mechanism 100 can further include two adhesive elements GEL1, which are disposed between the first movable part 108 and the base 112.

In this embodiment, the adhesive elements GEL1 may have an elastic material. The adhesive element GEL1 may be gel, for example, but it is not limited thereto. It is worth noting that the adhesive elements GEL1 are not disposed between the first movable part 108 and the second movable part 109.

In addition, as shown in FIG. 3, the adhesive elements GEL1 of this embodiment is arranged in a symmetrical configuration, for example, symmetrically with respect to the first axis AX1 (the central axis), and the optical element OE is located between the two adhesive elements GEL1. Based on such a configuration, the stability of the first movable part 108 and the second movable part 109 during movement can be increased.

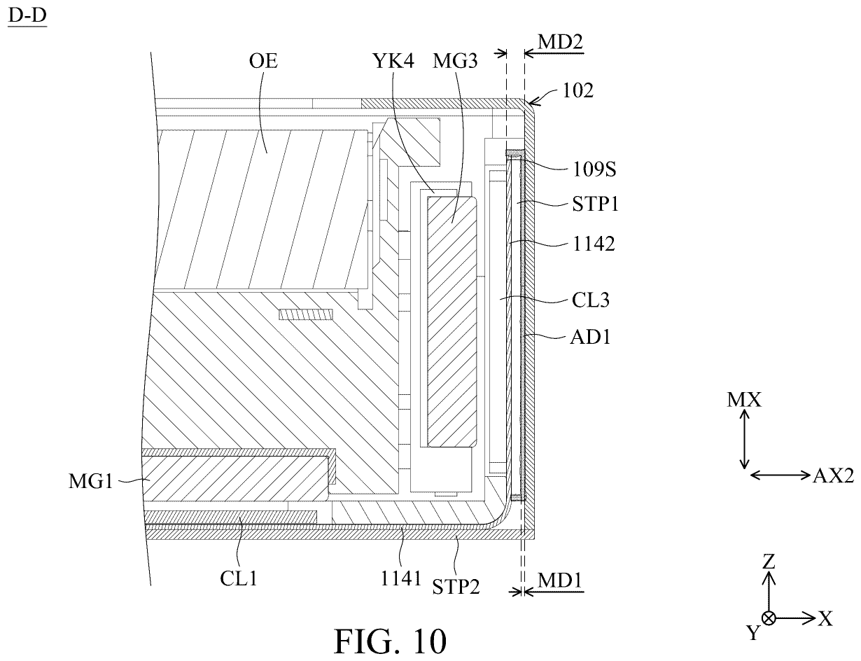

Next, please refer to FIG. 2 and FIG. 10. FIG. 10 is a cross-sectional view of the optical element driving mechanism 100 along line D-D in FIG. 1 according to an embodiment of the present disclosure. In this embodiment, the circuit assembly 114 may have a first circuit portion 1141 and a second circuit portion 1142, and the first circuit portion 1141 is connected to the second circuit portion 1142.

The first circuit portion 1141 extends along the second axis AX2, the second circuit portion 1142 is bent from the first circuit portion 1141 and extends along the main axis MX, and the first coil CL1 and the third coil CL3 are respectively disposed on the first circuit portion 1141 and second circuit portion 1142.

Furthermore, as shown in FIG. 2, the base 112 has a side opening HP1, and when viewed along the second axis AX2, the third coil CL3 can be exposed from the side opening HP1. That is, the third coil CL3 is disposed in the side opening HP1.

In addition, the optical element driving mechanism 100 may further include a first reinforcement plate body STP1, which is disposed in the side opening HP1 and is fixedly connected to the second circuit portion 1142. The first reinforcement plate body STP1 can be made of metal material and configured to strengthen the structural strength of the second circuit portion 1142. Based on the configuration of the first reinforcement plate body STP1, the problem of damage caused by the second circuit portion 1142 falling toward the casing 102 due to gravity can be avoided.

It is worth noting that, as shown in FIG. 10, when viewed along the first axis AX1, there is a first shortest distance MD1 between the first reinforcement plate body STP1 and the casing 102. There is a supporting surface 109S located in the side opening HP1, and there is a second shortest distance MD2 between the supporting surface 109S and the casing 102. The supporting surface 109S is configured to support the second circuit portion 1142.

The first shortest distance MD1 is less than the second shortest distance MD2. Based on this configuration, the problem of damage caused by the collision between the second circuit portion 1142, the first reinforcement plate body STP1 and the casing 102 can be avoided.

In addition, it should be noted that in this embodiment, the first reinforcement plate body STP1 is made of non-magnetic conductive material so as to avoid interfering the magnetic field of the third driving element MG3.

In some embodiments, the casing 102 can be made of metal material, and the optical element driving mechanism 100 can further include a first connecting element AD1, which is disposed between the first reinforcement plate body STP1 and the casing 102.

The first connecting element AD1 is, for example, glue, but it is not limited thereto. Because a portion of the first connecting element AD1 is in contact with the base 112, the base 112 can be fixedly connected to the casing 102.

Furthermore, as shown in FIG. 2 and FIG. 10, the optical element driving mechanism 100 may further include a second reinforcement plate body STP2, which is disposed at the bottom of the base 112, and the first circuit portion 1141 is disposed on the second reinforcement plate body STP2.

The second reinforcement plate body STP2 can be made of metal material, and the second plate body STP2 can be fixedly connected to the casing 102 by welding to more firmly fix other elements of the optical element driving mechanism 100 in the casing 102.

The present disclosure provides an optical element driving mechanism 100, which can be a periscope lens mechanism, including a fixed assembly FA, a movable assembly MA, and a driving assembly DA. The movable assembly MA includes a first movable part 108 and a second movable part 109. The first movable part 108 can be flexibly connected to the second movable part 109 through a first elastic member 106, and the second movable part 109 can be movable connected to the base 112 of fixed assembly FA through a second elastic member 110.

The optical element driving mechanism 100 further includes two first guiding elements BG1, which are disposed between the first movable part 108 and the second movable part 109, and the two first guiding elements BG1 can form a first rotating axis RX1, so that the first movable part 108 can rotate around the first rotating axis RX1 relative to the second movable part 109. Similarly, the optical element driving mechanism 100 further includes two second guiding elements BG2, which are disposed between the second movable part 109 and the base 112, and the two second guiding elements BG2 can form a second rotating axis RX2, so that the second movable part 109 can rotate around the second rotating axis RX2 relative to the base 112.

It is worth noting that because the movable assembly MA is divided into a first movable part 108 and a second movable part 109, and are supported by the first elastic members 106 and the second elastic members 110 respectively. Therefore, based on this configuration, the weight of the camera lens (the optical element OE) is distributed to the first movable part 108, the first elastic members 106, the second movable part 109, and the second elastic members 110, so that the optical element driving mechanism 100 can carry a heavier lens, and this configuration can also improve the precision of the first moving part 108 and the second moving part 109 during motion, thereby achieving better imaging performance.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly:
a movable assembly, configured to be connected to an optical element, wherein the movable assembly is movable relative to the fixed assembly; and
a driving assembly, configured to drive the movable assembly to move relative to the fixed assembly;
wherein the fixed assembly includes an accommodating space configured to accommodate the optical element.

2. The optical element driving mechanism as claimed in claim 1, wherein
the fixed assembly includes a casing and a base;
the casing is fixedly connected to the base along a main axis;
the casing has a first opening, and when viewed along the main axis, the optical element is exposed from the first opening;
the casing has a second opening, and when viewed along a first axis, the optical element is exposed from the second opening;
the first opening is connected to the second opening; and
an external light is emitted into the first opening along an optical axis and then enters the optical element, and then emitted from the optical element and the second opening along the first axis.

3. The optical element driving mechanism as claimed in claim 2, wherein
the movable assembly includes a first movable part and a second movable part;
the first movable part is movably connected to the second movable part;
the second movable part is movably connected to the base;
the driving assembly includes a first driving element and a first coil;
the first driving element is disposed on the first movable part;
the optical element driving mechanism further includes a circuit assembly, and the first coil is disposed on the circuit assembly; and
the first driving element is configured to act with the first coil to generate a first electromagnetic driving force to drive the first movable part to rotate around a first rotating axis relative to the second movable part.

4. The optical element driving mechanism as claimed in claim 3, wherein
the driving assembly further includes a second driving element, a third driving element, a second coil and a third coil;
the second driving element and the third driving element are disposed on the second movable part;
the second coil is disposed on the base;
the third coil is disposed on the circuit assembly;
the second driving element is configured to act with the second coil to generate a second electromagnetic driving force, and the third driving element is configured to act with the third coil to generate a third electromagnetic driving force, so that the second electromagnetic driving force and the third electromagnetic driving force cooperatively drive the first movable part and the second movable part to rotate around a second rotating axis relative to the base;
the first rotating axis is perpendicular to the second rotating axis;
the first rotating axis is perpendicular to the first axis; and
the second rotating axis is parallel to the main axis.

5. The optical element driving mechanism as claimed in claim 4, wherein
the optical element driving mechanism further includes a first elastic member which is connected between the first movable part and the second movable part;
the first elastic member has a first connecting terminal, a second connecting terminal and a first flexible portion;
the first connecting terminal is fixedly connected to the first movable part, the second connecting terminal is fixedly connected to the second movable part, and the first flexible portion is connected between the first connecting terminal and the second connecting terminal;
the optical element driving mechanism further includes a second elastic member which is connected between the second movable part and the base;
the second elastic member has a third connecting terminal, a fourth connecting terminal and a second flexible portion; and
the third connecting terminal is fixedly connected to the second movable part, the fourth connecting terminal is fixedly connected to the base, and the second flexible portion is connected between the third connecting terminal and the fourth connecting terminal.

6. The optical element driving mechanism as claimed in claim 5, wherein
the first elastic member and the second elastic member are both located on a rear side of the movable assembly;
the second connecting terminal has a plate-shaped structure and is located on a first plane;
the third connecting terminal has a plate-shaped structure and is located on a second plane; and
the first plane is parallel to the second plane.

7. The optical element driving mechanism as claimed in claim 4, wherein
the optical element driving mechanism further includes a reinforced base portion and a first reinforcement structure;
the first reinforcement structure is fixedly connected to the reinforced base portion;
at least a portion of the reinforced base portion and the first reinforcement structure are disposed in the first movable part;
the first driving element is disposed on the first reinforcement structure, and a portion of the first reinforcement structure is located between the first driving element and the first movable part;
the first reinforcement structure has a first side portion, a second side portion and a third side portion, which are arranged on three sides of the first driving element; and
the first side portion is adjacent to the second side portion, and the second side portion is adjacent to the third side portion.

8. The optical element driving mechanism as claimed in claim 7, wherein
the optical element driving mechanism further includes two first guiding elements, which are disposed between the first movable part and the second movable part and are configured to guide the first movable part to rotate around the first rotating axis;
the first rotating axis passes through the two first guiding elements;
the optical element driving mechanism further includes two first plate bodies, which are fixedly disposed on the second movable part;
each of the two first plate bodies has a first recess configured to accommodate a portion of the corresponding first guiding element;
the optical element driving mechanism further includes two second reinforcement structures, which are partially disposed in the first movable part;
the reinforced base portion is connected between the two second reinforcement structures;
each of the second reinforcement structures has a first contact portion configured to contact the corresponding first guiding element; and
each of the two first guiding elements is clamped by the corresponding first contact portion and the first plate body.

9. The optical element driving mechanism as claimed in claim 8, wherein
the optical element driving mechanism further includes two first attracting elements, which are fixedly disposed on the first movable part;
the first movable part has two first grooves, which are configured to respectively accommodate the two first attracting elements;
the optical element driving mechanism further includes two second attracting elements, which are fixedly disposed on the second movable part and respectively correspond to the first attracting elements;
the second movable part has two second grooves, configured to respectively accommodate the two second attracting elements;
the two first attracting elements and the two second attracting elements are made of magnetic materials;
the two first attracting elements are configured to generate two first magnetic attraction forces with the two second attracting elements respectively, and the two first magnetic attraction forces are parallel to the main axis; and
the two first magnetic attraction forces are configured to drive the first movable part toward the second movable part.

10. The optical element driving mechanism as claimed in claim 9, wherein
the first movable part further has two third grooves, configured to accommodate the two first guiding elements;
each of the two third grooves is connected to the corresponding first groove;
the first attracting element is adjacent to the corresponding first contact portion, and an attractive force is generated between the first attracting element and the corresponding first contact portion to position the first attracting element;
when viewed along the first axis, the two first guiding elements are located between the two first attracting elements;
when viewed along the first axis, the two first guiding elements are located between the two second attracting elements; and
the first attracting element and the second attracting element are adjacent to the corresponding first guiding element.

11. The optical element driving mechanism as claimed in claim 10, wherein
the optical element driving mechanism further includes a third reinforcement structure and a fourth reinforcement structure, which are partially disposed in the second movable part;
the second driving element is disposed on the third reinforcement structure, and a portion of the third reinforcement structure is located between the second driving element and the second movable part;
the third reinforcement structure has a fourth side portion and a fifth side portion, which are arranged on two sides of the second driving element; and
the fourth side portion is adjacent to the fifth side portion.

12. The optical element driving mechanism as claimed in claim 11, wherein
the third driving element is disposed on the fourth reinforcement structure, and a portion of the fourth reinforcement structure is located between the third driving element and the second movable part;
the fourth reinforcement structure has a sixth side portion and a seventh side portion, which are arranged on two sides of the third driving element; and
the sixth side portion is adjacent to the seventh side portion.

13. The optical element driving mechanism as claimed in claim 12, wherein
the optical element driving mechanism further includes two second guiding elements, which are disposed between the second movable part and the base and are configured to guide the second movable part and the first movable part to rotate around the second rotating axis;
the second rotating axis passes through the two second guiding elements;
the optical element driving mechanism further includes a second plate body, which is fixedly disposed on the base; and
when viewed along a second axis, the two second guiding elements are located between the second movable part and the second plate body.

14. The optical element driving mechanism as claimed in claim 13, wherein
the second axis is perpendicular to the first axis;
in a direction of the second axis, there is a first distance between the two first guiding elements;
in a direction of the main axis, there is a second distance between the two second guiding elements;
the second distance is different from the first distance; and
the second distance is less than the first distance.

15. The optical element driving mechanism as claimed in claim 14, wherein
the optical element driving mechanism further includes a fifth reinforcement structure which is partially disposed in the second movable part;
the third reinforcement structure and the fourth reinforcement structure are fixedly connected to the fifth reinforcement structure;
the third reinforcement structure, the fourth reinforcement structure and the fifth reinforcement structure are integrally formed as one piece;
the second plate body has a second recess and a third recess, configured to respectively accommodate a portion of the two second guiding elements;
the fifth reinforcement structure has a second contact portion and a third contact portion configured to respectively contact the two second guiding elements;
one of the two second guiding elements is clamped by the second contact portion and the second plate body; and
the other of the two second guiding elements is clamped by the third contact portion and the second plate body.

16. The optical element driving mechanism as claimed in claim 15, wherein
the first movable part has a first accommodating space, and a portion of the second movable part is located within the first accommodating space;
the base has a back plate and a protruding portion, and the protruding portion protrudes from the back plate along the first axis toward the second movable part;
a portion of the protruding portion is located in the first accommodating space;
the optical element driving mechanism further includes a third attracting element, which is fixedly disposed on the protruding portion;
the third attracting element is made of magnetic material; and
the fifth reinforcement structure is made of magnetically conductive material.

17. The optical element driving mechanism as claimed in claim 16, wherein
the fifth reinforcement structure further has a bending structure which is located between the second contact portion and the third contact portion;
when viewed along the second axis, a portion of the bending structure does not overlap the second contact portion or the third contact portion;
the third attracting element is configured to generate a second magnetic attraction force with the bending structure, and the second magnetic attraction force is parallel to the first axis; and
the second magnetic attraction force is configured to drive the fifth reinforcement structure to drive the second movable part to move toward the base, so that the fifth reinforcement structure and the second plate body cooperatively clamp the two second guiding elements.

18. The optical element driving mechanism as claimed in claim 17, wherein
the optical element driving mechanism further includes at least one adhesive element which is disposed between the first movable part and the base;
the adhesive element has elastic material;
the adhesive element is not disposed between the first movable part and the second movable part; and
the optical element driving mechanism includes two adhesive elements, and the optical element is located between the two adhesive elements.

19. The optical element driving mechanism as claimed in claim 18, wherein
the circuit assembly has a first circuit portion and a second circuit portion, and the first circuit portion is connected to the second circuit portion;
the first circuit portion extends along the second axis;
the second circuit portion is bent from the first circuit portion and extends along the main axis;
the first coil and the third coil are respectively disposed on the first circuit portion and the second circuit portion; and
the base has a side opening, and when viewed along the second axis, the third coil is exposed from the side opening.

20. The optical element driving mechanism as claimed in claim 19, wherein
the optical element driving mechanism further includes a first reinforcement plate body, which is disposed in the side opening and is fixedly connected to the second circuit portion;
the first reinforcement plate body is configured to strengthen a structural strength of the second circuit portion;
when viewed along the first axis, there is a first shortest distance between the first reinforcement plate body and the casing, there is a supporting surface located in the side opening;
there is a second shortest distance between the supporting surface and the casing;
the supporting surface is configured to support the second circuit portion;
the first shortest distance is less than the second shortest distance;
the first reinforcement plate body is made of non-magnetic conductive material;
the casing is made of metal;
the optical element driving mechanism further includes a first connecting element, which is disposed between the first reinforcement plate body and the casing;
the optical element driving mechanism further includes a second reinforcement plate body, which is fixedly connected to the casing; and
the first circuit portion is disposed on the second reinforcement plate body.
